(19) United States
(12) Patent Application Publication
(10) Pub. No.: US 2013/0069512 A1
(43) Pub. Date: Mar. 21, 2013

(54) ACTUATED DOOR OPENING MECHANISM FOR MICROWAVE AND SPEEDCOOKING PRODUCTS

(71) Applicants: Tom C. Zimmer, Louisville, KY (US); Derrick Douglas Little, Louisville, KY (US); Shawn Michael Stover, Louisville, KY (US)

(72) Inventors: Tom C. Zimmer, Louisville, KY (US); Derrick Douglas Little, Louisville, KY (US); Shawn Michael Stover, Louisville, KY (US)

(73) Assignee: General Electric Company

(21) Appl. No.: 13/236,157

(22) Filed: Sep. 19, 2011

(51) Int. Cl. H05B 1/00

(52) U.S. Cl. 312/326

(57) ABSTRACT

The disclosure relates to a door opening mechanism for a cooking device. The device includes a body defining a cooking chamber and a door operatively mounted to the body to provide access to the cooking chamber while maintaining a closed insulated barrier while in use. A sensor is mounted the body for providing a signal to retaining member when activated. A retaining member is mounted within the body to hold a latch attached to the door. The latch is released from the retaining member when a signal is provided by the sensor to the actuator retaining member that provides a positive drive force to release the latch and open the door.

### BACKGROUND OF THE DISCLOSURE

The present disclosure relates to an actuated door opening mechanism, and more particularly an actuated door opening mechanism for a cooking appliance or device operated by a touch sensor device.

In conventional cooking appliances such as microwave ovens, a cooking chamber is provided to house an associated food product while having a closed or substantially sealed barrier. The sealed barrier is insulated and prevents the unwanted leakage of microwave energy or heat to the surrounding atmosphere while the cooking appliance is in use. The sealed barrier of the cooking chamber is oriented to allow a user or homeowner to have sufficient access to the associated food product that is cooked within the appliance.

Generally, access to the cooking chamber is provided by a door that has certain structural and functional attributes necessary to maintain a sealed barrier. These characteristics include providing insulation within the door and body of the cooking device, as well as having geometrically interconnected contoured edges aligned between the body and the door when closed. Hinges are provided about the door and have sufficient strength or reinforcement to allow for smooth operation and to prevent binding during opening and closing movements. The hinges are preferably located outside of the cooking chamber and do not impinge upon the sealed barrier. The door remains closed during use of the cooking device to prevent unwanted leakage of microwave energy or heat loss.

It is also known for cooking devices to include an interlock switch that provides a signal to the cooking device indicating when the door is in the closed position. When the door is opened, the interlock switch provides a signal to the cooking device indicating to shut off power supplied to the cooking chamber simultaneously with the opening of the door. This safety feature is generally known within the prior art and prevents the unwanted leakage of microwave energy from the cooking chamber.

Additionally, cooking devices include an opening mechanism to allow an associated user to open a securely closed door for access to the cooking chamber. There are many different types of door opening mechanisms available that are known within the prior art. Opening mechanisms are designed to rely upon an applied force supplied by the associated user to disengage a latch from a retaining member located within a guide hole or aperture contained by the body of the cooking device. Retaining members are known to be comprised of an arrangement of springs, guide members, and pivot joints within the body that receive and hold a latch to securely close the door to the body or housing of the cooking device.

Many cooking devices use a handle operatively mounted to an exterior surface of the door to manipulate the latch and thereby engage or disengage the door from the body. Other devices use a statically mounted handle whereby the latch is manipulated by a spring force coupled with an angular shaped or hooked portion of the latch to engage or disengage the door from the retaining member. However, a predetermined force must be applied to the handle by the user to overcome the spring force and effectively open and close the door of these cooking devices.

It is also known in the prior art to provide a push button or plunger type opening mechanism. Typical push buttons are mounted to the face of the cooking device and arranged adjacent to the door to manipulate the springs, guide members, etc., of the retaining member. However, push buttons also require an associated force provided by a user to manipulate the retaining member which disengages the latch and opens the door.

The associated force must be substantial enough to displace the latch from the arrangement within the body of the cooking device. The required force required to open/close the door varies as a function of the retaining member orientation and spring force constants, as well as a number of possible geometric design arrangements. Mechanical bindings and internal guide member friction forces also affect the amount of associated force necessary to displace the retainer and disengage the latch. Additionally, the position of the user relative to the cooking device. The user may be holding a food dish or tray and be unable to supply the required force to overcome the spring or latching force to open or close the door.

For the foregoing reasons, there is a need to provide an opening mechanism for a cooking device that does not require a substantial associated force to open the door for access to the cooking chamber.

### SUMMARY

The present disclosure relates to a touch sensor used as an opening mechanism that allows a user to open the door of a cooking device without applying a large opening or closing force.

A preferred opening mechanism includes a body defining a cooking chamber and a door operatively mounted to the body to provide access to the cooking chamber while maintaining a closed barrier while in use. A touch sensor or tactile switch is mounted substantially flush to the exterior of the body and provides a signal to an actuator retaining member when engaged by an associated finger or dielectric object. The touch sensor/tactile switch comprises a substantially planar boundary area that can detect the presence of an associated finger or dielectric object within the boundary area. An actuator retaining member is located within the body of the cooking device that operatively receives and holds the latch. The latch engages the actuator retaining member while the door is in a closed position and thereby maintains a sealed barrier for the cooking chamber. The latch is released from the actuator retaining member when a signal is provided by the touch sensor. Further, the actuator retaining member provides a positive drive force to the latch and places the door in the open position without the use of an associated substantial force.

Touch sensor or tactile switch systems and displays coupled with a mechanism capable of providing a positive drive force eliminate the need for a substantial force applied to handles, mechanical buttons, keypads, keyboards, and pointing devices. For example, a user can carry out a sequence of instructions by touching an on-display touch screen to generate a signal to operate the appropriate function. The actuator retaining member also advantageously supplies a positive drive force to effectively disengage the latch from the retainer and thereby open the door.

A preferred embodiment includes a door opening mechanism for a cooking device that has a touch sensor/tactile switch and an actuator. An elongated bracket is provided within the door subject to a spring force and connects to a pawl and latch which extend outwardly towards the body to engage an actuator and retaining member, respectively located within the body. The touch sensor/tactile switch provides a signal to the actuator that supplies a positive drive force to the pawl thereby displacing the elongated bracket subject to the spring force and disengaging the latch from the retaining member and thereby opening the door without the use of substantial force.

Another preferred embodiment uses a capacitive touch screen as the touch sensor. The capacitive touch screen is responsive to an input or a conductive object such as a finger or a dielectric object. The capacitive touch screen measures capacitance caused by the touch, and uses the measured capacitance to determine touch presence. The touch screen recognizes the difference in capacitance and provides an output signal indicating touch occurrence.

Still another preferred embodiment uses a resistive touch screen as the touch sensor. The resistive touch screen includes two thin, electrically conductive layers separated by a narrow gap. The resistive touch screen registers the touch when the two conductive layers come into contact which causes a change in the electrical current and generates the signal.

Yet another preferred embodiment provides feedback to a user when a haptic or touch event is acknowledged on the touch sensor. The feedback can be visual, audible, or physical, or any combination of the three, to verify that a touch has occurred.

Still other benefits and advantages of the disclosure will become apparent upon reading and understanding the following detailed description.

### BRIEF DESCRIPTION OF THE DRAWINGS

FIG. 1 is an isometric view of the microwave with the door in the open position.

FIG. 2 is an enlarged view of the microwave latching arrangement.

FIG. 3 is a side view partially in cross-section of the microwave with the door in the closed position.

### DETAILED DESCRIPTION

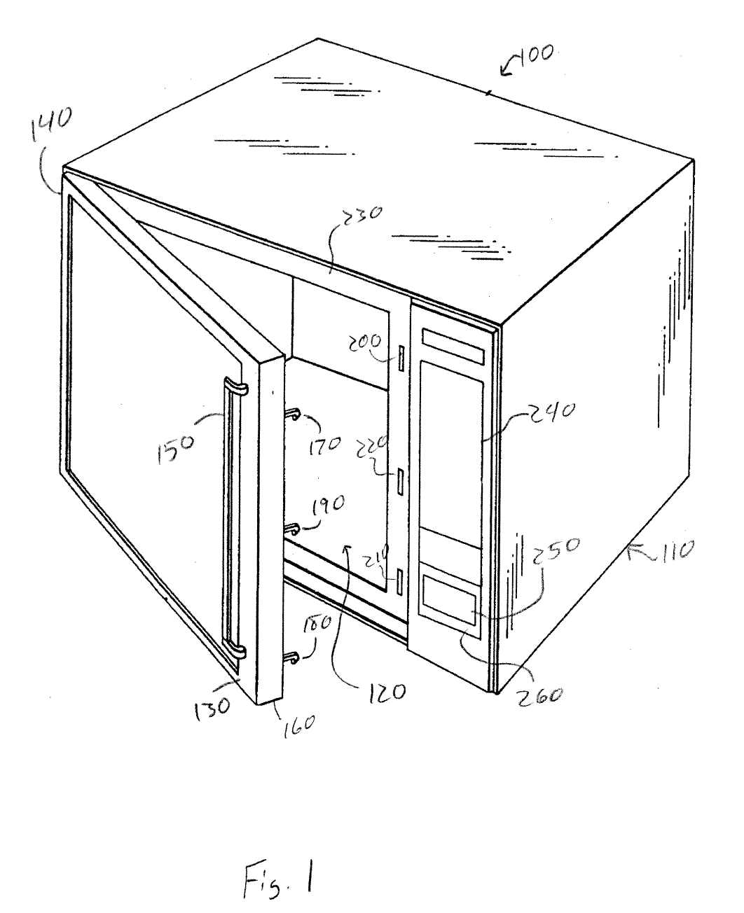

Referring to FIG. 1, there is shown a speedcooking appliance or microwave oven 100 comprising an outer housing, casing or body 110 enclosing a cooking chamber 120. A front opening of the cooking chamber 120 is closed by a door 130 hinged along one edge or end 140 and having a handle 150 at the opposite edge or end 160. A plurality of latches 170, 180 and a pawl 190 are positioned about the opposite end 160 of the door 130 and extend from a rear face of the door toward the body. The latches 170, 180 and pawl 190 are operatively located to be received through the respective slots 200, 210, 220 arranged in the face 230 of the cooking chamber 120 surrounding the front opening. The latches 170, 180 selectively lock the door in the closed position and provide a substantially sealed barrier about the cooking chamber 120 to prevent unwanted energy loss while the microwave oven 100 is activated.

The face 230 of the microwave 100 preferably has a control panel 240 for the general control of the microwave 100 and to select the desired mode of cooking, a timer, a display, clock, etc. A touch sensor or tactile switch 250 is provided on a portion of the face 230 to allow an associated user to open the door 130 by bringing a finger or other dielectric object into contact or proximity with the touch sensor. The touch sensor 250 is generally mounted flush along the face 230 and includes a boundary area 260 that is generally rectangular but may also be arranged in any practical geometric shape that can be adapted to encompass any available area based on the design criteria of the face 230. There are several types of sensor technologies that are known within the prior art and this disclosure is not limited in this regard. Known technologies include the use of capacitive, resistive, surface wave, strain gauge, optical imaging, and infrared technologies amongst others that can sense the finger or dielectric object in contact with or closely adjacent with the touch sensor. Tactile switches can be activated by either buttons or through a protective film. Of course, touch sensors and tactile switches are preferred embodiments but the present disclosure should not be limited to these arrangements.

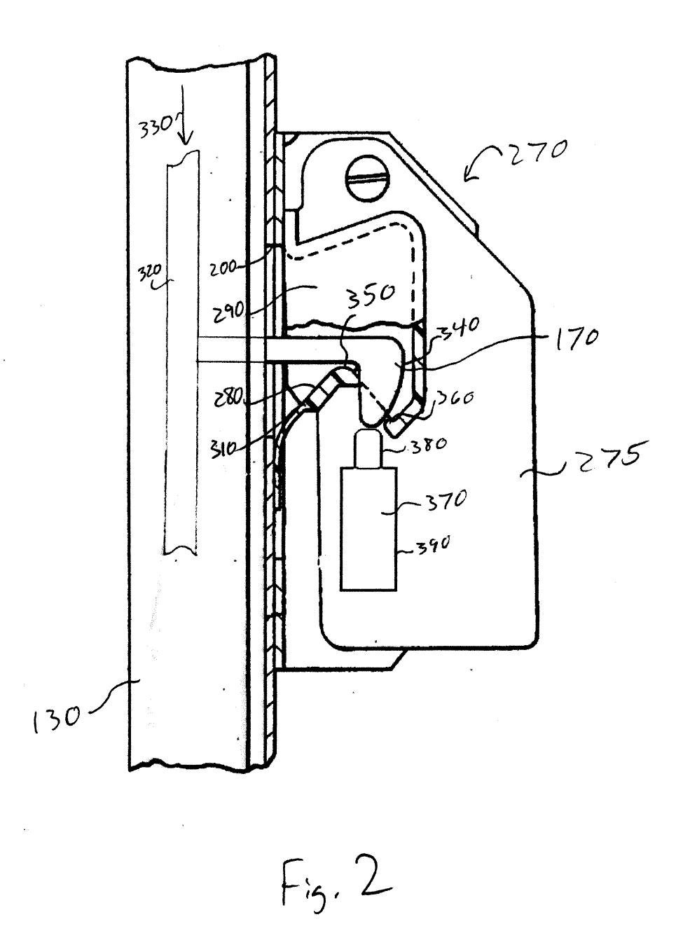

With additional reference to FIG. 2, there is shown an actuator retaining member 270 that preferably includes a bracket 275 and an actuator 370 located within the body 110 of the microwave oven 100. The representative latch 170 penetrates the slot 200 and engages the bracket 275 that is configured or oriented to hold the latch 170 and lock the door in the closed position. The bracket 275 is formed of a structurally rigid material such as plastic or metal that can be shaped to provide an inclined surface or plate 280 that allows a leading face of the latch to ride over until an undercut region of the latch 170 physically engages the bracket and retains the latch 170 within a cavity 290 that communicates rearwardly of the slot 200.

More particularly, the latch 170 has a hooked portion 340 that is adapted to engage the bracket 270 inwardly of the inclined plane 280 as the latch is advanced through the slot 200, slides over the inclined surface 280, and into the cavity 290. The hooked portion 340 extends past a pinnacle or shoulder 350 of the inclined plate 280 where a segment of the latch is received through an opening 360 provided within the cavity 290. The hooked portion 340 is shaped to engage the bracket 270 to lock the door in the closed position.

Once the door 130 is in the process of being closed by an associated user, the hooked portion 340 of the latch 170 engages the base 310 of the inclined surface 280 and forces the latch 170 to shift in an upward direction while maintaining a substantially perpendicular orientation in relation to the door 130. An elongated bracket 320 is mounted within the door 130 and interconnects the latch 170 to a plurality of similar latches to allow for the uniform motion of the latches engaging similar brackets. The elongated bracket 320 is biased by a spring force represented by reference numeral 330 located within the door 130 and urges the latch over the pinnacle 350 of the inclined surface thereby locking the door 130 in the closed position subject to overcoming the predetermined spring force 330.

An actuator 370 is mounted to the bracket 270 and oriented to physically abut or engage the hooked portion 340 when the door is in the closed position. The actuator 370 may include any conventional automated mechanism including but not limited to a solenoid valve, a rotating cam, or linear drive. As shown in FIG. 2, the actuator 370 includes a drive member or actuating pin 380 that is operatively connected to the drive base or solenoid 390 and positioned on the bracket 275. The actuator means 370 is electrically interconnected with the touch sensor 250 to receive an open signal provided in the form of a valid touch on the touch sensor. In response to the touch sensor providing a signal, the drive pin is extended from the solenoid base 390 to physically engage the hooked portion 340 and urge or force the latch 170 upwardly over the shoulder 350 to disengage the latch from the inclined plate 280. The hooked portion is shaped to interact with the inclined plate 280 in such a way that once the latch 170 is disengaged from the opening 360 and overcomes the spring force 330, the same spring force urges the latch to proceed toward the inclined surface 280 and thereby opens the door. The shape of the hooked portion 340 interacting with the inclined surface 280 and subject to constant spring force 330 effectively urges the hooked portion 340 over the pinnacle 350 and thereby opens the door 130.

FIG. 2 shows the actuator 370 oriented in a generally parallel orientation relative to the door 130. However, the driving mechanism 370, bracket 275, cavity 290 and hooked portion 340 may be oriented in such a way that allows the actuator 370 to be mounted in a different angular relation relative to the bracket and hooked portion without departing from the scope and intent of the present disclosure.

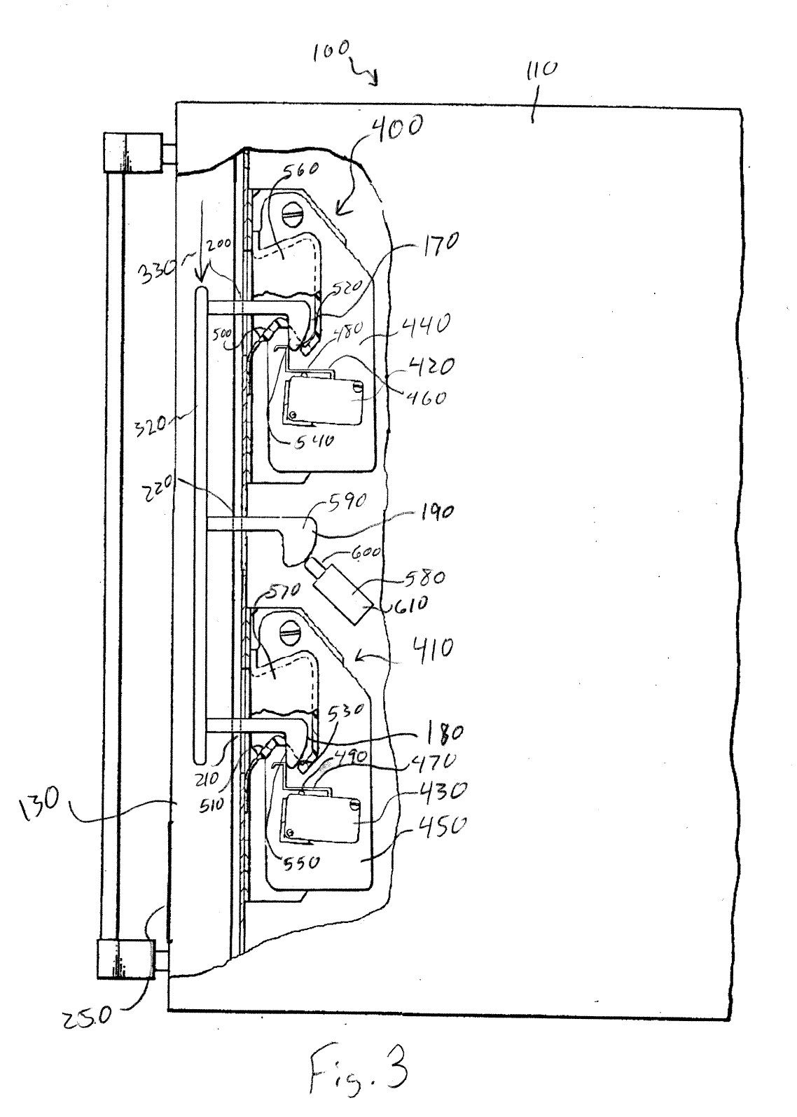

FIG. 3 shows a preferred embodiment of the present disclosure whereby the addition of a pawl 190 is provided. The microwave oven 100 is depicted to have two retaining members 400, 410 mounted within the body 110. Specifically, retaining member 400 is operatively associated with slot 200 and interacts with latch 170 while retaining member 410 is operatively associated with slot 210 and interacts with latch 180. The use of multiple retaining members provides increased locking force to provide a secure closed position.

Retaining members 400, 410 include interlock switches 420, 430 mounted to respective brackets 440, 450. Interlock switches are generally well known in the prior art and function as a shut off switch linked to the operation of the microwave oven 100. The brackets 440, 450 have a substantially similar arrangement as bracket 275 from FIG. 2 however an interlock switch is provided in place of the actuator.

The interlock switches 420, 430 have actuating arms 460, 470, respectively, which are used utilized in such a way that depression of the actuating arms 460, 470 by latches 170, 180 also depress projections or buttons 480, 490 that activate the interlock switches 420, 430. The actuating arms 460, 470 are located adjacent to inclined plates 500, 510 in such a way that the segments 520, 530 of the latches 170, 180 protrude though openings 540, 550 of cavities 560, 570 and depress the respective actuating arms 460, 470 when the door 130 is in the closed position. When depressed, the interlock switches 420, 430 provide a signal indicating that the door is closed thereby allowing the operation of the microwave oven 100. Release of the actuating arms 460, 470 releases the buttons 480, 490 and, in turn, deactivates the interlock switches 420, 430 to shut off operation of the microwave oven.

Pawl 190 is mounted to elongated bracket 320 in a substantially parallel arrangement to latches 170, 180. The elongated bracket 320 provides uniform motion of latches 170, 180 and pawl 190 subject to the biasing spring force 330 within the door 130. The pawl 190 selectively penetrates slot 220 and is aligned to engage actuator 580. The actuator 580 is mounted within the body 110 of the microwave oven 100 and preferably arranged between retaining members 400, 410 for selective operative interaction of head portion 590 of the pawl 190 with the actuator 580.

The actuator 580 includes a drive pin 600 that is operatively connected to the solenoid or drive base 610. The actuator 580 is electrically interconnected with the touch sensor 250 to receive an open signal from the touch sensor 250. In response to the signal, the drive pin 600 is extended from the drive base 610 to engage the head portion 590 and move the pawl 190 in an upward, release direction. The actuator 580 drives the pawl 190 a predetermined distance to raise the elongated bracket 320 and displace the latches 170, 180 upwardly to a disengaged position relative to inclined surfaces 500, 510 and open the door of the microwave oven.

The actuator 580 may use alternative drive mechanisms including but not limited to a solenoid, rotating cam, rack and gear linear drive, etc. In addition, the touch sensor 250 may also provide feedback or a haptic effect indicating to an associated user that the sensor has been actuated. For example, the feedback may include a physical, visual or audible notification.

The disclosure has been described with respect to the preferred embodiments. Obviously, modifications and alterations will occur to others upon reading and understanding the preceding detailed description. It is intended that the disclosure be construed as including such modifications and alteration in so far as they come within the scope of the appended claims or the equivalents thereof.

We claim:

1. A door opening mechanism for a cooking device comprising:
a body defining a cooking chamber and a door operatively mounted to the body to provide access to the cooking chamber while adapted to maintain a closed insulated barrier while in use;
a sensor mounted to the exterior of the body for providing a signal when activated by a dielectric object;
a retaining member operatively adapted to hold a latch attached to the door, the latch engaging the actuator retaining member while the door is in a closed position and releasing the retaining member in response to the signal provided by the sensor.

2. The mechanism of claim 1 wherein the retaining member provides a positive drive force to the latch to release the latch and move the door to the open position.

3. The mechanism of claim 1 wherein the sensor comprises a capacitive touch screen surface.

4. The mechanism of claim 1 wherein the sensor comprises a resistive touch surface or tactile switch.

5. The mechanism of claim 1 wherein the sensor comprises a wave touch surface.

6. The mechanism of claim 1 further comprising a feedback indicating an audible haptic effect in response to activating the sensor.

7. The mechanism of claim 1 wherein the sensor includes a visual indicator to provide feedback.

8. The mechanism of claim 1 wherein the retaining member further includes an interlock switch adapted to inactivate the cooking device when disengaged from the latch.

9. The mechanism of claim 1 wherein the retaining member includes a solenoid member for releasing the latch.

10. A door opening mechanism for a microwave oven comprising:
a body defining a cooking chamber and a door operatively mounted to the body to provide access to the cooking chamber;
a sensor mounted to an exterior surface of the body to provide a signal to an actuator when activated by an associated dielectric object;
an actuator responsive to the sensor for opening the door;
an elongated bracket mounted within the door comprising a pawl and a latch extending from the door towards the body, the latch operatively engaging a retaining member of the body when the door is in a closed position, a biasing force provided to the elongated bracket,;
an actuator operatively engaging the pawl to provide a positive drive force to the pawl and overcome the biasing force whereby the latch is disengaged from the retaining member.

11. The mechanism of claim 10 wherein the sensor comprises a capacitive touch screen surface.

12. The mechanism of claim 10 wherein the sensor comprises a resistive touch surface.

13. The mechanism of claim 10 further comprising a feedback mechanism that provides a feedback indicating at least one of an audible, visual or physical haptic effect in response to the

14. The mechanism of claim 10 wherein the actuator retaining member comprises at least one interlock switch adapted to shut down a cooking means of the cooking device when disengaged from the latch.

15. A method for opening a door for a cooking device comprising:
providing a cooking device with a cooking chamber within a body and a door operatively mounted to the body;
providing a sensor on the body;
providing an actuator that is interconnected with the sensor;
mounting a latch to the door for selective engagement with the actuator,
generating a signal to the actuator in response to activating the sensor and thereby directing the actuator to release the latch and place the door in an open position.

16. The method of claim 15 wherein an elongated bracket is operatively mounted within the door comprising a latch extending from the door towards the body and operatively engages a retaining member when the door is in the closed position.

17. The method of claim 15 further including biasing the elongated bracket toward a door open or closed position.

18. The method of claim 15 further comprising actuating a pawl to release the latch in response to the sensor signal.

19. The method of claim 15 wherein the sensor providing step includes providing a touch screen that sends the signal responsive to a dielectric object in close proximity or contacting the touch screen.

20. The method of claim 19 further including providing a feedback when the touch screen is activated.
